(19) United States
(12) Patent Application Publication
(10) Pub. No.: US 2024/0085858 A1
(43) Pub. Date: Mar. 14, 2024

(54) SMART WATCH

(71) Applicant: Dongguan Wujiang Technology Investment Co., Ltd., Dongguan (CN)

(72) Inventors: Yangde Li, Dongguan (CN); Wenxuan Li, Dongguan (CN); Mixin Tang, Dongguan (CN); Yi Li, Dongguan (CN); Yucheng Liang, Dongguan (CN); Mingyang Cui, Dongguan (CN)

(21) Appl. No.: 17/931,094

(22) Filed: Sep. 9, 2022

(51) Int. Cl. G04G 21/02; G04G 9/00; G04G 21/08; H04R 1/02

(52) U.S. Cl. CPC G04G 21/02; G04G 9/007; G04G 21/08; H04R 1/028

(57) ABSTRACT

The present invention discloses a smart watch, including a housing with a mounting cavity, a top cover that covers the housing, a movement in the mounting cavity, a watch dial for displaying time, a light emitting module, a shake sensing module, a tap sensing module, and an audio player. The light emitting module is configured to be turned on when the shake sensing module senses that the smart watch is shaken and turned off when the tap sensing module senses that the smart watch is tapped. The audio player is configured to be started when the smart watch is tapped or shaken. According to the present invention, when needing to turn on the light emitting module, a user only needs to shake the smart watch worn on his/her wrist, and when needing to turn off the light emitting module, the user only needs to tap the smart watch with his/her hand. Compared with the way of turning on the light emitting module by pressing a physical button, the smart watch is simpler and more convenient in operation.

### TECHNICAL FIELD

The present invention relates to the technical field of electronic products, and in particular to a smart watch.

### BACKGROUND

At present, in order to make it easier for users to see the time displayed by watches at night or in poor light, watches on the market are often provided with light emitting modules. However, existing light emitting modules of watches are turned on by manually pressing physical buttons, and users need to grope for positions of the buttons at night or in poor light, which is inconvenient for use. In addition, for some watches that display time through electronic display screens, when the electronic display screens are turned off, the electronic display screens are also turned on by pressing physical buttons, which is inconvenient for use.

Therefore, there is an urgent need to provide a smart watch that uses a new way to turn on or off a light emitting module, so as to solve the foregoing problems in the prior art.

### SUMMARY OF THE INVENTION

An objective of the present invention is to provide a smart watch of which a light emitting module is turned on or off conveniently and quickly.

In order to achieve the above objective, the present invention provides a smart watch, including a housing with a mounting cavity, a top cover that covers the housing, a movement in the mounting cavity, a watch dial for displaying time, a light emitting module, a shake sensing module, and a tap sensing module. The light emitting module is configured to be turned on when the shake sensing module senses that the smart watch is shaken and turned off when the tap sensing module senses that the smart watch is tapped.

In an embodiment, the shake sensing module is an acceleration sensor, the smart watch further includes a control module, the shake sensing module is electrically connected to the control module, and the control module controls to turn on the light emitting module on the basis of acceleration information sent by the shake sensing module.

Specifically, the control module includes a first comparator, a non-inverting input terminal of the first comparator is connected to the shake sensing module, an inverting input terminal of the first comparator is connected to a first reference threshold, and when an acceleration sensed by the shake sensing module is greater than the first reference threshold, the first comparator outputs a first trigger signal to turn on the light emitting module.

In an embodiment, the light emitting module is turned off when the tap sensing module senses that the smart watch is tapped again within a first preset time after sensing that the smart watch is tapped.

In an embodiment, the smart watch further includes an audio player, where the audio player is electrically connected to the control module, the control module controls to start the audio player when receiving the acceleration information again within a second preset time; or control to start the audio player when the tap sensing module senses only one tap within the first preset time.

In an embodiment, the tap sensing module is a pressure sensor, the pressure sensor is electrically connected to the control module, and the control module controls to turn off the light emitting module on the basis of pressure information sent by the tap sensing module.

Specifically, the control module includes a second comparator, an inverting input terminal of the second comparator is connected to the tap sensing module, a non-inverting input terminal of the second comparator is connected to a second reference threshold, and when the tap sensing module senses that a pressure is greater than the second reference threshold, the second comparator outputs a second trigger signal to turn off the light emitting module.

In an embodiment, the watch dial is a liquid crystal panel, and the light emitting module is a backlight module disposed on a side, facing away from the top cover, of the watch dial.

In an embodiment, the light emitting module includes a plurality of LED lights, and the plurality of LED lights are disposed on a side, facing toward the top cover, of the watch dial.

In an embodiment, the light emitting module includes a plurality of LED lights, the watch dial is pervious to light, and the plurality of LED lights are disposed on the side, facing away from the top cover, of the watch dial.

Compared with the prior art, the present invention is provided with the shake sensing module and the tap sensing module; the shake sensing module senses whether the smart watch is shaken, and when sensing that the smart watch is shaken, the light emitting module is turned on to bring convenience for a user to check the time and perform related operations; the tap sensing module senses whether the smart watch is tapped, and when sensing that the smart watch is tapped, the light emitting module is turned off to save electric power. According to the present invention, when needing to turn on the light emitting module, the user only needs to shake the smart watch worn on his/her wrist, and when needing to turn off the light emitting module, the user only needs to tap the smart watch with his/her hand. Compared with the way of turning on the light emitting module by pressing a physical button, the smart watch is simpler and more convenient in operation.

### BRIEF DESCRIPTION OF DRAWINGS

FIG. 1 is a front view of a smart watch according to an embodiment of the present invention.

FIG. 2 is a cross-sectional view of a smart watch according to an embodiment of the present invention.

FIG. 3 is a cross-sectional view of a smart watch according to another embodiment of the present invention.

FIG. 4 is a front view of a smart watch according to another embodiment of the present invention.

FIG. 5 is a block diagram of part of components of a smart watch according to an embodiment of the present invention.

FIG. 6 is a partial circuit diagram of a smart watch according to an embodiment of the present invention.

FIG. 7 is a partial circuit diagram of a smart watch according to an embodiment of the present invention.

### DETAILED DESCRIPTION OF EMBODIMENTS

In order to describe the technical content and structural features of the present invention in detail, further description is given below in conjunction with embodiments and the accompanying drawings. Similar elements in the figures represent similar elements.

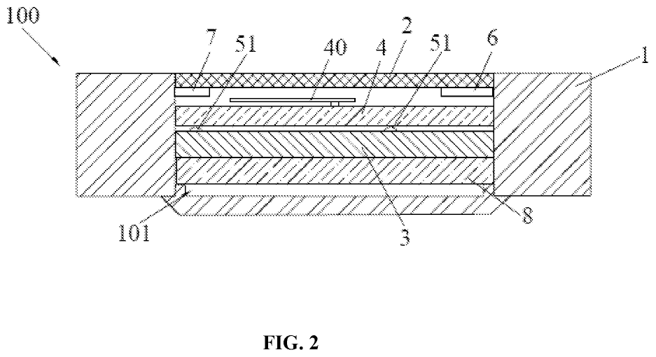

Referring to FIG. 2 first, a smart watch 100 provided in the present invention includes a housing 1 with a mounting cavity 101, a transparent top cover 2 that covers the housing 1, a movement 3, a watch dial 4 for displaying time, a light emitting module 5, a shake sensing module 6, a tap sensing module 7, and a battery 8, the movement 3, the watch dial 4, the shake sensing module 6, the tap sensing module 7, and the battery 8 being disposed in the mounting cavity 101. The shake sensing module 6 is configured to sense whether the smart watch 100 is shaken, and the tap sensing module 7 is configured to sense whether the smart watch 100 is tapped. The light emitting module 5 is configured to be turned on when the shake sensing module 6 senses that the smart watch 100 is shaken, so as to bring convenience for a user to check the time and perform related operations, and turned off when the tap sensing module 7 senses that the smart watch 100 is tapped, so as to save electric power.

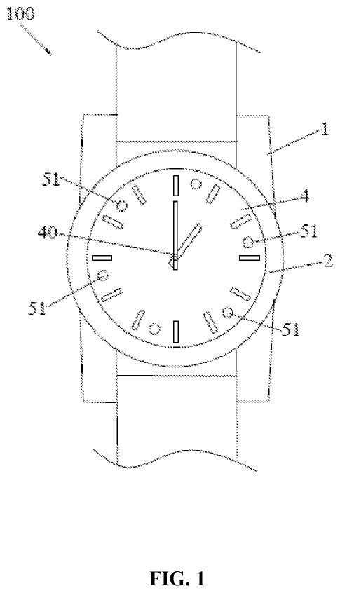

The smart watch 100 of the present invention will be described below in detail with reference to FIG. 1 to FIG. 7 of the accompanying drawings.

Referring to FIG. 1 to FIG. 3 first, in the embodiments shown in FIG. 1 to FIG. 3, a side, facing toward the top cover 2, of the watch dial 4 is provided with scale lines and pointers 40 rotatably assembled on the watch dial 4 and coaxially arranged with the scale lines, and a current time point is indicated by the pointers 40 pointing the corresponding scale lines. The light emitting module 5 includes a plurality of LED lights 51. Light rays emitted from the plurality of LEDs light 51 illuminate the side, facing toward the top cover 2, of the watch dial 4 to bring convenience for the user to check the time.

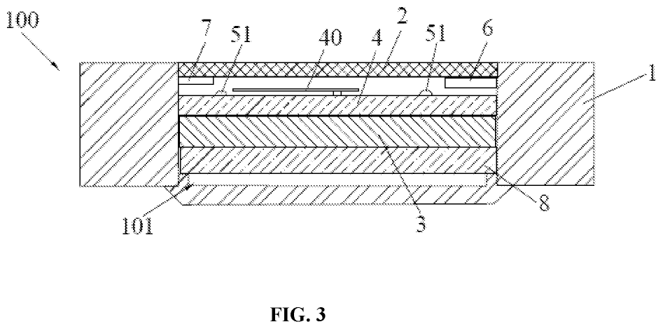

In the embodiment shown in FIG. 2, the watch dial 4 is made of a material pervious to light, the plurality of LED lights 51 are disposed apart on a side, facing away from the top cover 2, of the watch dial 4, and light rays emitted by the plurality of LED lights 51 are projected through the watch dial 4 to the side, facing toward the top cover 2, of the watch dial 4. In the embodiment shown in FIG. 3, the plurality of LED lights 51 are disposed apart on the side, facing toward the top cover 2, of the watch dial 4. In the embodiment shown in FIG. 3, the plurality of LED lights 51 are disposed between the top cover 2 and the watch dial 4. Optionally, in some embodiments, the LED lights 51 may be disposed, at the periphery of the top cover 2, on the outer side of the housing 1.

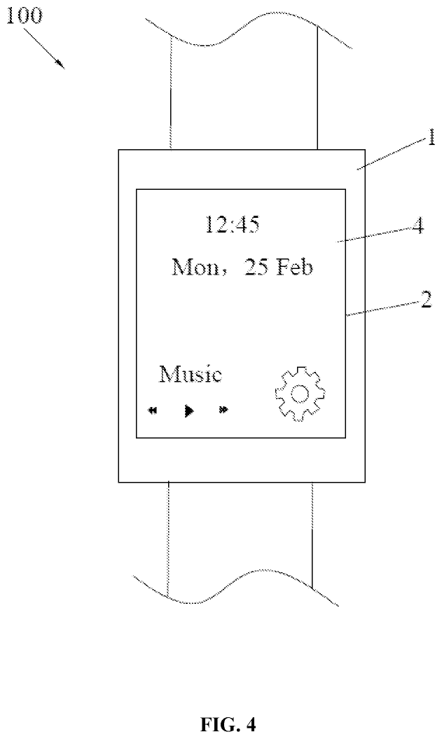

Next, referring to FIG. 4, in the embodiment shown in FIG. 4, the watch dial 4 is a liquid crystal panel, and the light emitting module 5 is a backlight module disposed on the side, facing away from the cover 2, of the watch dial 4. That is, the watch dial 4 and the light emitting module 5 form a liquid crystal display screen, and the liquid crystal display screen digitally displays a time point. When the user checks the time or performs some operations, the liquid crystal display screen can be turned on by shaking the smart watch 100.

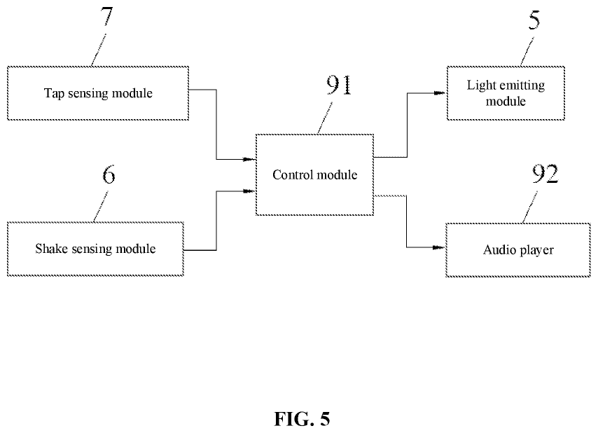

Then referring to FIG. 5, the smart watch 100 further includes a control module 91, the shake sensing module 6 is an acceleration sensor, the shake sensing module 6 is electrically connected to the control module 91, and the control module 91 controls to turn on the light emitting module 5 on the basis of acceleration information sent by the shake sensing module 6. The tap sensing module 7 is a pressure sensor, the pressure sensor 7 is electrically connected to the control module 91, and the control module 91 controls to turn off the light emitting module 5 on the basis of pressure information sent by the tap sensing module 7.

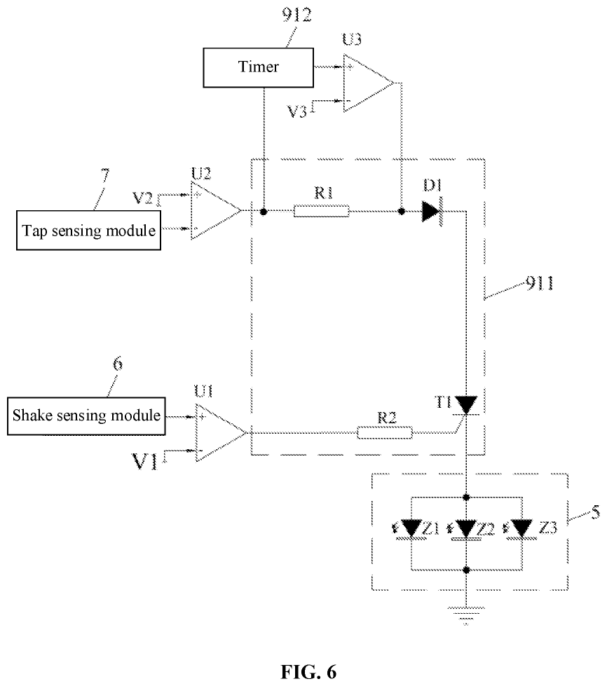

Specifically, as shown in FIG. 6, the control module 91 includes a first comparator U1, a second comparator U2, and a switch unit 911. A non-inverting input terminal of the first comparator U1 is connected to the shake sensing module 6, an inverting input terminal of the first comparator U1 is connected to a first reference threshold V1, the switch unit 911 is connected between an output terminal of the first comparator U1 and the light emitting module 5, and when an acceleration sensed by the shake sensing module 6 is greater than the first reference threshold V1, the first comparator U1 outputs a first trigger signal (high-level signal) to switch on the switch unit 911 so as to turn on the light emitting module 5. An inverting input terminal of the second comparator U2 is connected to the tap sensing module 7, a non-inverting input terminal of the second comparator U2 is connected to a second reference threshold V2, an output terminal of the second comparator U2 is connected to the switch unit 911, and when the tap sensing module 7 senses that a pressure is greater than the second reference threshold V2, the second comparator U2 outputs a second trigger signal (low-level signal) to switch off the switch unit 911 so as to turn off the light emitting module 5.

In the embodiment shown in FIG. 6, the switch unit 911 includes a thyristor T1, a diode D1, a resistor R1, and a resistor R2. One end of the resistor R1 is connected to the output terminal of the second comparator U2, and the other end is connected to an anode of the diode D1. A cathode of the diode D1 is connected to an anode of the thyristor T1. One end of the resistor R2 is connected to the output terminal of the first comparator U1, and the other end is connected to a control electrode of the thyristor T1. A cathode of the thyristor T1 is connected to a plurality of LED lights Z1, Z2 and Z3, and the plurality of LED lights Z1, Z2, and Z3 are connected in parallel. When the user does not tap the smart watch 100, the second comparator U2 constantly outputs a high-level signal, the diode D1 remains on, and the anode of the thyristor T1 is of a high level. When the acceleration information output by the shake sensing module 6 causes the first comparator U1 to output a high-level signal, the thyristor T1 is switched on, so that the LED lights Z1, Z2, and Z3 are turned on. After the user taps the smart watch 100, the second comparator U2 outputs a low level, the diode D1 is cut off, the anode of the thyristor T1 is of a low level, and the thyristor T1 is cut off, so that the LED lights Z1, Z2, and Z3 are turned off.

Further, in the embodiment shown in FIG. 6, the control module 91 further includes a timer 912 connected to the output terminal of the second comparator U2 and a third comparator U3 of which a non-inverting input terminal is connected to the timer 912. The timer 912 can be triggered at a low level. When the user taps the smart watch 100 to make the second comparator U2 output a low level, the timer 912 starts to measure the time. An inverting input terminal of the third comparator U3 is connected to a third reference threshold V3, and an output terminal of the third comparator U3 is connected to the anode of the diode D1. When a recorded duration of the timer 912 is greater than a preset duration (for example, 1 S, corresponding to the third reference threshold V3), the third comparator U3 outputs a high-level signal to switch on the diode D1 to make the anode of the thyristor T1 at a high level, and then the timer 912 is cleared. That is, after the user taps the smart watch 100 to turn off the LED lights Z1, Z2, and Z3 for the preset duration, the diode D1 is switched on again to make the anode of the thyristor T1 at a high level, and accordingly, when the user shakes the smart watch 100 next time to make the first comparator U1 output a high-level signal, the thyristor T1 can be switched on so that the LED lights Z1, Z2, and Z3 are turned on.

Incidentally, the shake sensing module 6 is not limited to using an acceleration sensor to sense a shake. The tap sensing module 7 is also not limited to using a pressure sensor to sense a tap, for example, it may also use a physical button or the like.

In addition, in the embodiment shown in FIG. 6, the LED lights Z1, Z2, and Z3 are turned off when a tap is sensed. In some embodiments, optionally, when the smart watch 100 is tapped again within a first preset time (for example, 0.5 S) after the tap sensing module 7 senses that the smart watch 100 is tapped, the LED lights Z1, Z2, and Z3 are turned off again. Specifically, it can be implemented by designing a timing circuit, for example, start control of the audio player 92 below, which will not be repeated here.

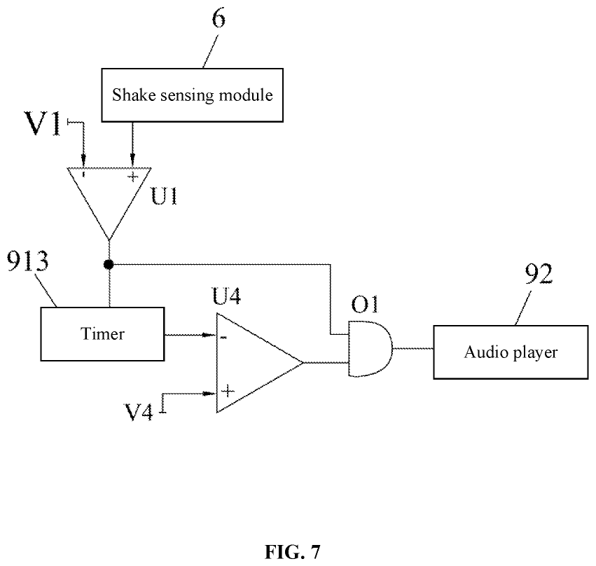

Next, referring to FIG. 5 and FIG. 7, the smart watch 100 further includes an audio player 92, and the audio player 92 is electrically connected to the control module 91. The control module 91 further includes a timer 913, a fourth comparator U4, and an AND gate O1. The timer 913 is connected to the output terminal of the first comparator U1. A non-inverting input terminal of the fourth comparator U4 is connected to a fourth reference threshold V4 (a voltage signal, corresponding to the following second preset time). An inverting input terminal of the fourth comparator U4 is connected to the timer 913. An output terminal of the fourth comparator U4 is connected to a first input terminal of the AND gate O1. A second input terminal of the AND gate O1 is connected to the output terminal of the first comparator U1. An output terminal of the AND gate O1 is connected to the audio player 92. When the first comparator U1 outputs a high level, the timer 913 starts to measure the time. When a recorded duration of the timer 913 is less than the second preset time, the fourth comparator U4 outputs a high level. If the first comparator U1 outputs a high level again within the second preset time, the AND gate O1 outputs a high level, the audio player 92 is started, and the smart watch 100 starts to play a sound, such as music.

Of course, the manner in which the control module 91 controls to start the audio player 92 is not limited to using the foregoing circuit structure, and other logic circuits may also be used in the specific implementation, which will not be repeated here.

In addition, in the embodiment that the LED lights Z1, Z2, and Z3 are turned off when the smart watch 100 is tapped again within the first preset time (for example, 0.5 S) after the tap sensing module 7 senses that the smart watch 100 is tapped, the audio player 92 can be started by tapping. For example, when the tap sensing module 7 senses only one tap at the first preset time, the audio player 92 is controlled to start.

The operation method and principle of the smart watch of the present invention will be described below by taking a specific embodiment as an example:

When the light-emitting module 5 needs to be turned on for checking the time and performing the related operations, the smart watch 100 is shaken, and then the light emitting module 5 can be selected to be always on or automatically turned off without any operation within a preset time (for example, turned off if no operation is performed for one minute, which can be implemented by an existing program or logic circuit). When the audio player 92 needs to be started to play a sound, the smart watch 100 is tapped, and then the audio player 92 can be selected to be in a working state all the time or automatically shut down if no operation is performed within a preset time (for example, shut down if no operation is performed for one minute, which can be implemented by an existing program or logic circuit). The light emitting module 5 can be turned off and the audio player 92 can be shut down as needed by continuously tapping the smart watch 100 within the first preset time.

In conclusion, the present invention is provided with the shake sensing module 6 and the tap sensing module 7; the shake sensing module 6 senses whether the smart watch 100 is shaken, and when sensing that the smart watch 100 is shaken, the light emitting module 5 is turned on, so as to bring convenience for the user to check the time and perform related operations; the tap sensing module 7 senses whether the smart watch 100 is tapped, and when sensing that the smart watch 100 is tapped, the light emitting module 5 is turned off, so as to save electric power. According to the present invention, when needing to turn on the light emitting module 5, the user only needs to shake the smart watch 100 worn on his/her wrist, and when needing to turn off the light emitting module 5, the user only needs to tap the smart watch with his/her hand. Compared with the way of turning on the light emitting module 5 by pressing a physical button, the smart watch is simpler and more convenient in operation.

What disclosed above are only preferred examples of the present invention, and cannot limit the scope of the claims of the present invention. Therefore, the equivalent changes made according to the claims of the present invention all shall fall within the scope covered by the present invention.

I claim:

1. A smart watch, characterized by comprising a housing with a mounting cavity, a top cover that covers the housing, a movement in the mounting cavity, a watch dial for displaying time, a light emitting module, a shake sensing module, and a tap sensing module, wherein the light emitting module is configured to be turned on when the shake sensing module senses that the smart watch is shaken and turned off when the tap sensing module senses that the smart watch is tapped.

2. The smart watch according to claim 1, characterized in that the shake sensing module is an acceleration sensor, the smart watch further comprises a control module, the shake sensing module is electrically connected to the control module, and the control module controls to turn on the light emitting module on the basis of acceleration information sent by the shake sensing module.

3. The smart watch according to claim 2, characterized in that the control module comprises a first comparator, a non-inverting input terminal of the first comparator is connected to the shake sensing module, an inverting input terminal of the first comparator is connected to a first reference threshold, and when an acceleration sensed by the shake sensing module is greater than the first reference threshold, the first comparator outputs a first trigger signal to turn on the light emitting module.

4. The smart watch according to claim 2, characterized in that the light emitting module is turned off when the tap sensing module senses that the smart watch is tapped again within a first preset time after sensing that the smart watch is tapped.

5. The smart watch according to claim 4, characterized by further comprising an audio player, wherein the audio player is electrically connected to the control module, the control module controls to start the audio player when receiving the acceleration information again within a second preset time; or control to start the audio player when the tap sensing module senses only one tap within the first preset time.

6. The smart watch according to claim 2, characterized in that the tap sensing module is a pressure sensor, the pressure sensor is electrically connected to the control module, and the control module controls to turn off the light emitting module on the basis of pressure information sent by the tap sensing module.

7. The smart watch according to claim 6, characterized in that the control module comprises a second comparator, an inverting input terminal of the second comparator is connected to the tap sensing module, a non-inverting input terminal of the second comparator is connected to a second reference threshold, and when the tap sensing module senses that a pressure is greater than the second reference threshold, the second comparator outputs a second trigger signal to turn off the light emitting module.

8. The smart watch according to claim 1, characterized in that the watch dial is a liquid crystal panel, and the light emitting module is a backlight module disposed on a side, facing away from the top cover, of the watch dial.

9. The smart watch according to claim 1, characterized in that the light emitting module comprises a plurality of LED lights, and the plurality of LED lights are disposed on a side, facing toward the top cover, of the watch dial.

10. The smart watch according to claim 1, characterized in that the light emitting module comprises a plurality of LED lights, the watch dial is pervious to light, and the plurality of LED lights are disposed on the side, facing away from the top cover, of the watch dial.
